(19) United States
(12) Patent Application Publication
(10) Pub. No.: US 2018/0199584 A1
(43) Pub. Date: Jul. 19, 2018

(54) DEVICE, SYSTEM AND METHOD FOR PRODUCING A YOGHURT PRODUCT

(71) Applicant: LECKER LABS LIMITED, Kowloon Bay (HK)

(72) Inventors: Ashok JAISWAL, Kowloon Bay (HK); Jon BUFORD, Kowloon (HK)

(73) Assignee: LECKER LABS LIMITED, Kowloon Bay (HK)

(21) Appl. No.: 15/713,553

(22) Filed: Sep. 22, 2017

(30) Foreign Application Priority Data
Jan. 18, 2017 (HK) 17100621.8
Sep. 18, 2017 (HK) 17109457.8

(51) Int. Cl. A23C 9/12

(52) U.S. Cl. CPC A23C 9/1223

(57) ABSTRACT

A device for use in making a yoghurt product, the device including: a base station having a reservoir associated therewith for holding a yoghurt product pre-mixture; a stirrer for stirring the yoghurt product pre-mixture; a heating device; a cooling device; a temperature sensor module; and a controller module operatively-connected to the temperature sensor module and configured for controlling the heating device and the cooling device to heat and cool the yoghurt product pre-mixture in the reservoir respectively, by reference to output signals of the temperature sensor received by the controller module indicative of the temperature of the yoghurt product pre-mixture in the reservoir, so as to form the yoghurt product.

This application claims priority to Hong Kong Application No. 17100621.8 filed on Jan. 18, 2017 and Hong Kong Application No. 17109457.8 filed on Sep. 18, 2017, the contents of which are incorporated by reference in their entirety herein.

### TECHNICAL FIELD

The present invention relates to the field of yoghurt making in the context of non-commercial home user yoghurt making.

### BACKGROUND OF THE INVENTION

Yoghurt is consumed throughout the world by many millions of people on a daily basis. Typically, during the yoghurt making process, it is desirable that a yoghurt product pre-mixture (i.e. comprising milk constituent and a yoghurt culture constituent) is heated, stirred and cooled in accordance with suitable temperature and timing settings so as to produce a desired type of yoghurt product. Certain existing devices have been developed for the home-user market to assist in the production of relatively small quantities of yoghurt product for home user consumption. In relation to certain existing yoghurt making devices and systems, the steps of heating and cooling the yoghurt product pre-mixture is required to be performed in physically separate vessels and/or using separate kitchen appliances in order to achieve a yoghurt product of suitable texture and quality. The use of multiple vessels and/or kitchen appliances is inconvenient for the user as these additional items incur additional purchase costs and take up additional storage space, it introduces additional complexities in to the process of producing the yoghurt product, and requires the user constantly monitor the cooking process so as to manually transfer the heated yoghurt product pre-mixture from the heating vessel into the separate stirring/cooling vessel at the appropriate time to ensure that the yoghurt product is properly formed.

### SUMMARY OF THE INVENTION

The yoghurt product present invention seeks to alleviate at least one of the above-described problems.

The yoghurt product present invention may involve several broad forms. Embodiments of the yoghurt product present invention may include one or any combination of the different broad forms herein described.

In a first broad form, the present invention provides a device for use in making a yoghurt product, the device including: a base station having a reservoir associated therewith for holding a yoghurt product pre-mixture; a stirrer for stirring the yoghurt product pre-mixture; a heating device; a cooling device; a temperature sensor module; and a controller module operatively-connected to the temperature sensor module and configured for controlling the heating device and the cooling device to heat and cool the yoghurt product pre-mixture in the reservoir respectively, by reference to output signals of the temperature sensor received by the controller module indicative of the temperature of the yoghurt product pre-mixture in the reservoir, so as to form the yoghurt product.

Preferably, the yoghurt product pre-mixture may include an effective amount of a milk constituent and an effective amount of a yoghurt culture constituent.

Preferably, the yoghurt product pre-mixture may include an effective amount of a flavour constituent.

Typically, the heating device and the cooling device may include an integrated heating and cooling device.

Typically, the integrated heating and cooling device may include a thermoelectric Peltier device.

Preferably, the heating device and the cooling device may be comprised by separate devices.

Preferably, the heating device may include at least one of a metallic heating device, a ceramic heating device, and a polymer heating device.

Preferably, the heating device may be configured for heating the yoghurt product pre-mixture to a temperature of around 85 degrees Celsius.

Preferably, the cooling device may include a thermoelectric Peltier device.

Preferably, the heating device and the cooling device may include a heat transfer element via which the heating device and the cooling device effect heat transfer in to and out of the yoghurt product pre-mixture.

Preferably, the heat transfer element may be mounted adjacent to a top section of the base station and includes a first region configured for extending downwardly from the top section into contact with the yoghurt product pre-mixture within the reservoir.

Preferably, the heat transfer element may include a second region configured for thermal communication with the cooling device.

Preferably, the second region of the heat transfer element may include a substantially planar surface configured for lying substantially flush against the cooling device.

Preferably, the heat transfer element may include a third region comprising a hollow recess of the heat transfer element configured for receiving the heating element therein.

Preferably, the present invention may include a dispenser for dispensing at least one of the milk constituent, the yoghurt culture constituent and the flavour constituent into the reservoir to form the yoghurt product pre-mixture.

Preferably, the dispenser may include a receptacle for releasably receiving at least one of the milk constituent, the yoghurt culture constituent and the flavour constituent for dispensing into the reservoir to form the yoghurt product pre-mixture.

Preferably, the receptacle may include an opening and a blocking member configured for movement relative to the opening between at least a first position wherein the at least one of the milk constituent, the yoghurt culture constituent and the flavour constituent is able to be dispensed into the reservoir via the opening, and, a second position whereby the blocking member prevents the at least one of the milk constituent, the yoghurt culture constituent and the flavour constituent from being dispensed into the reservoir via the opening.

Preferably, the present invention may include a magnetic drive mechanism configured for moving the blocking member relative to the opening of the receptacle.

Preferably, at least one of the milk constituent, the yoghurt culture constituent and the flavour constituent are formed as a solid mass.

Preferably, the solid mass includes a compressed powder tablet.

Preferably, the stirrer may include a stirrer tool head configured for attachment to the first region of the heat transfer element extending in to the reservoir and wherein the first region of the heat transfer element is configured for rotation so as to rotate the stirrer tool head attached thereon.

Preferably, the stirrer tool head may be releasably attachable to the first region of the heat transfer element.

Preferably, the stirrer tool head may be configured for slide fitting over an end of the first region of the heat transfer element.

Preferably, the present invention includes a magnetic attachment mechanism disposed on at least one of the stirrer tool head and the heat transfer element to effect magnetic attachment of the stirrer tool head to the heat transfer element.

Preferably, the reservoir may be removably receivable within a recess of the base module.

Preferably, the present invention may include a venting module configured for venting water vapour from the reservoir when received within the recess of the base module.

Preferably, the venting module may be configured for moving the reservoir between at least one of a closed position whereby a gap between a rim of the reservoir and the top section of the base station is at a relative minimum, and, an opened position whereby the gap between the rim of the reservoir and the top section of the base station is at a relative maximum.

Preferably, the venting module may be configured for moving the reservoir upwardly and downwardly within the recess between the closed position and the opened position by sliding motion along a linear axis.

Alternately, the venting module may be configured for tilting, rotating or sliding the reservoir vertically within the recess from the closed position in to the opened position in order to vent the water vapour from the reservoir.

Preferably, the present invention may include a controller module configured for controlling operation of at least one of the dispenser, the stirrer, the temperature sensor module, the heating device, and the cooling device in accordance with at least one predefined operational mode setting for producing the yoghurt product.

Preferably, the controller module may be configured for controlling operation of at least one of the dispenser, the stirrer, the temperature sensor module, the heating device, and the cooling device in accordance with a plurality of different predefined operational mode settings to produce a plurality of different types of yoghurt products.

Preferably, the controller module may be communicably connected with a data store for storing data representing the at least one predefined operational mode setting, whereby the controller module may be able to access the data from the data store in order to control operation of the at least one of the dispenser, the stirrer, the temperature sensor module, the heating device, and the cooling device in accordance with the at least one predefined operational mode setting for producing the yoghurt product.

Preferably, the data store may include at least one of a data store of the device, a server-side data store, and a cloud-based data store.

Preferably, the controller module may be communicably connected with a user-interactive interface via which the at least one predefined operational mode setting may be selected by the user, and responsive to said selection being made, the controller module is configured for controlling operation of the at least one of the dispenser, the stirrer, the temperature sensor module, the heating device, and the cooling device in accordance with the at least one predefined operational mode setting for producing the yoghurt product.

Preferably, the user-interactive interface may be comprised by an electronic device configured for remote connection with the controller module via a communication link.

Preferably, the electronic device may include at least one of a smartphone, a tablet-type device and a portable computer.

Preferably, the communication link may include at least one wireless communication link.

Preferably, the present invention may include at least one of a weight sensor and a proximity sensor configured for sensing the yoghurt product presence of the milk constituent in the reservoir, wherein responsive to said sensing of the yoghurt product presence of the milk constituent in the reservoir, the controller module may be configured for controlling operation of the at least one of the dispenser, the stirrer, the temperature sensor module, the heating device, and the cooling device in accordance with the at least one predefined operational mode setting for producing the yoghurt product.

Preferably, the at least one predefined operational mode setting may include at least one of a predefined stirring time of the stirrer, a predefined heating temperature of the heating device, a predefined cooling temperature of the cooling device, a predefined heating time of the heating device, and a predefined cooling time of the cooling device.

Preferably, the user-interactive interface may be configured to output a notification in response to sensing of the yoghurt product having been formed in the reservoir.

Preferably, the microcontroller module may be configured for controlling operation of at least one of the dispenser, the stirrer, the temperature sensor module, the heating device, and the cooling device in accordance with at least one predefined operational mode setting for cleaning the reservoir.

In a further broad form, the present invention provides a method for producing a yoghurt product, the method including the steps of: (i) providing a base station having a reservoir associated therewith for holding a yoghurt product pre-mixture; (ii) providing a stirrer for stirring the yoghurt product pre-mixture; (iii) providing a heating device; (iv) providing a cooling device; (v) providing a temperature sensor module; and (vi) providing a controller module operatively-connected to the temperature sensor module and configured for controlling the heating device and the cooling device to heat and cool the yoghurt product pre-mixture in the reservoir respectively, by reference to output signals of the temperature sensor received by the controller module indicative of the temperature of the yoghurt product pre-mixture in the reservoir, so as to form the yoghurt product.

Preferably, the yoghurt product pre-mixture may include an effective amount of a milk constituent and an effective amount of a yoghurt culture constituent.

Preferably, the yoghurt product pre-mixture may include an effective amount of a flavour constituent.

Typically, the heating device and the cooling device may include an integrated heating and cooling device.

Preferably, the integrated heating and cooling device may include a thermoelectric Peltier device.

Preferably, the heating device and the cooling device may be comprised by separate devices.

Preferably, the heating device may include at least one of a metallic heating device, a ceramic heating device, and a polymer heating device.

Preferably, the heating device may be configured for heating the yoghurt product pre-mixture to a temperature of around 85 degrees Celsius.

Preferably, the cooling device may include a thermoelectric Peltier device.

Preferably, the heating device and the cooling device may include a heat transfer element via which the heating device and the cooling device effect heat transfer in to and out of the yoghurt product pre-mixture.

Preferably, the heat transfer element may be mounted adjacent to a top section of the base station and may include a first region configured for extending downwardly from the top section into contact with the yoghurt product pre-mixture within the reservoir.

Preferably, the heat transfer element may include a second region configured for thermal communication with the cooling device.

Preferably, the second region of the heat transfer element may include a substantially planar surface configured for lying substantially flush against the cooling device.

Preferably, the heat transfer element may include a third region comprising a hollow recess of the heat transfer element configured for receiving the heating element therein.

Preferably, the present invention may include a dispenser for dispensing at least one of the milk constituent, the yoghurt culture constituent and the flavour constituent into the reservoir to form the yoghurt product pre-mixture.

Preferably, the dispenser may include a receptacle for releasably receiving at least one of the milk constituent, the yoghurt culture constituent and the flavour constituent for dispensing into the reservoir to form the yoghurt product pre-mixture.

Preferably, the receptacle may include an opening and a blocking member configured for movement relative to the opening between at least a first position wherein the at least one of the milk constituent, the yoghurt culture constituent and the flavour constituent is able to be dispensed into the reservoir via the opening, and, a second position whereby the blocking member prevents the at least one of the milk constituent, the yoghurt culture constituent and the flavour constituent from being dispensed into the reservoir via the opening.

Preferably, the present invention may include a magnetic drive mechanism configured for moving the blocking member relative to the opening of the receptacle.

Preferably, at least one of the milk constituent, the yoghurt culture constituent and the flavour constituent may be formed as a solid mass.

Preferably, the solid mass may include a compressed powder tablet.

Preferably, the stirrer may include a stirrer tool head configured for attachment to the first region of the heat transfer element extending in to the reservoir and wherein the first region of the heat transfer element is configured for rotation so as to rotate the stirrer tool head attached thereon.

Preferably, the stirrer tool head may be releasably attachable to the first region of the heat transfer element.

Preferably, the stirrer tool head may be configured for slide fitting over an end of the first region of the heat transfer element.

Preferably, the present invention may include a magnetic attachment mechanism disposed on at least one of the stirrer tool head and the heat transfer element to effect magnetic attachment of the stirrer tool head to the heat transfer element.

Preferably, the reservoir may be removably receivable within a recess of the base module.

Preferably, the present invention may include a venting module configured for venting water vapour from the reservoir when received within the recess of the base module.

Preferably, the venting module may be configured for moving the reservoir between at least one of a closed position whereby a gap between a rim of the reservoir and the top section of the base station is at a relative minimum, and, an opened position whereby the gap between the rim of the reservoir and the top section of the base station is at a relative maximum.

Preferably, the venting module may be configured for moving the reservoir upwardly and downwardly within the recess between the closed position and the opened position by sliding motion along a linear axis.

Preferably, the venting module may be configured for tilting, rotating or sliding the reservoir vertically within the recess from the closed position in to the opened position in order to vent the water vapour from the reservoir.

Preferably, the present invention may include a controller module configured for controlling operation of at least one of the dispenser, the stirrer, the temperature sensor module, the heating device, and the cooling device in accordance with at least one predefined operational mode setting for producing the yoghurt product.

Preferably, the controller module may be configured for controlling operation of at least one of the dispenser, the stirrer, the temperature sensor module, the heating device, and the cooling device in accordance with a plurality of different predefined operational mode settings to produce a plurality of different types of yoghurt products.

Preferably, the controller module may be communicably connected with a data store for storing data representing the at least one predefined operational mode setting, whereby the controller module ay be able to access the data from the data store in order to control operation of the at least one of the dispenser, the stirrer, the temperature sensor module, the heating device, and the cooling device in accordance with the at least one predefined operational mode setting for producing the yoghurt product.

Preferably, the data store may include at least one of a data store of the device, a server-side data store, and a cloud-based data store.

Preferably, the controller module may be is communicably connected with a user-interactive interface via which the at least one predefined operational mode setting may be selected by the user, and responsive to said selection being made, the controller module may be configured for controlling operation of the at least one of the dispenser, the stirrer, the temperature sensor module, the heating device, and the cooling device in accordance with the at least one predefined operational mode setting for producing the yoghurt product.

Preferably, the user-interactive interface may be comprised by an electronic device configured for remote connection with the controller module via a communication link.

Preferably, the electronic device may include at least one of a smartphone, a tablet-type device and a portable computer.

Preferably, the communication link may include at least one wireless communication link.

Preferably, the present invention may include at least one of a weight sensor and a proximity sensor configured for sensing the yoghurt product presence of the milk constituent in the reservoir, wherein responsive to said sensing of the yoghurt product presence of the milk constituent in the reservoir, the controller module is configured for controlling operation of the at least one of the dispenser, the stirrer, the temperature sensor module, the heating device, and the cooling device in accordance with the at least one predefined operational mode setting for producing the yoghurt product.

Preferably, the at least one predefined operational mode setting may include at least one of a predefined stirring time of the stirrer, a predefined heating temperature of the heating device, a predefined cooling temperature of the cooling device, a predefined heating time of the heating device, and a predefined cooling time of the cooling device.

Preferably, the user-interactive interface may be configured to output a notification in response to sensing of the yoghurt product having been formed in the reservoir.

Preferably, the microcontroller module may be configured for controlling operation of at least one of the dispenser, the stirrer, the temperature sensor module, the heating device, and the cooling device in accordance with at least one predefined operational mode setting for cleaning the reservoir.

### BRIEF DESCRIPTION OF THE DRAWINGS

The yoghurt product present invention will become more fully understood from the following detailed description of a preferred but non-limiting embodiments thereof, described in connection with the accompanying drawings, wherein:

FIG. 1 shows a yoghurt making device for producing a yoghurt product in accordance with a first embodiment of the present invention;

FIG. 2 shows an exploded perspective view of the first embodiment yoghurt making device;

FIG. 3 shows a view of the base station of the device with the reservoir removed;

FIGS. 4(a) and 4(b) shows an exploded view of the reservoir of the device and an assembled view of the reservoir of the device;

FIG. 5 shows a top view of the stirrer element movably mounted to the bottom of the reservoir;

FIG. 6 shows a top perspective view of the device with the lid of the base station rotated into an opened configuration about a hinge to reveal 4 receptacles for releasably holding yoghurt culture and flavouring constituents in compressed powder tablet form to be controllably dispensed in to the reservoir;

FIG. 7 shows a flow chart of process steps for producing a yoghurt product in accordance with a further embodiment of the present invention;

FIG. 8 shows a functional block diagram of a PCB of the yoghurt making device in accordance with an embodiment of the present invention;

FIG. 9 shows a functional block diagram of a remote-control device for remotely controlling operation of the yoghurt making device via a communication link; and

FIG. 10 shows the first embodiment yoghurt making device communicably connected with the remote-control device via a WI-FI router in a wireless home network.

FIG. 11 shows a stirrer mechanism in accordance with a further embodiment of the present invention;

FIG. 12 shows a heating device, cooling device and common heat transfer element in stand-alone form in accordance with the further embodiment of the present invention;

FIGS. 13(a) and 13(b) shows a venting mechanism in stand-alone form in accordance with the further embodiment of the present invention, wherein FIG. 13(a) shows the venting mechanism arranging the reservoir in a venting configuration which assists in venting of excess water vapour from the reservoir, and, FIG. 13(b) shows the venting mechanism arranging the reservoir in a non-venting arrangement which assists in alleviating venting from the reservoir.

### DETAILED DESCRIPTION OF THE PREFERRED EMBODIMENTS

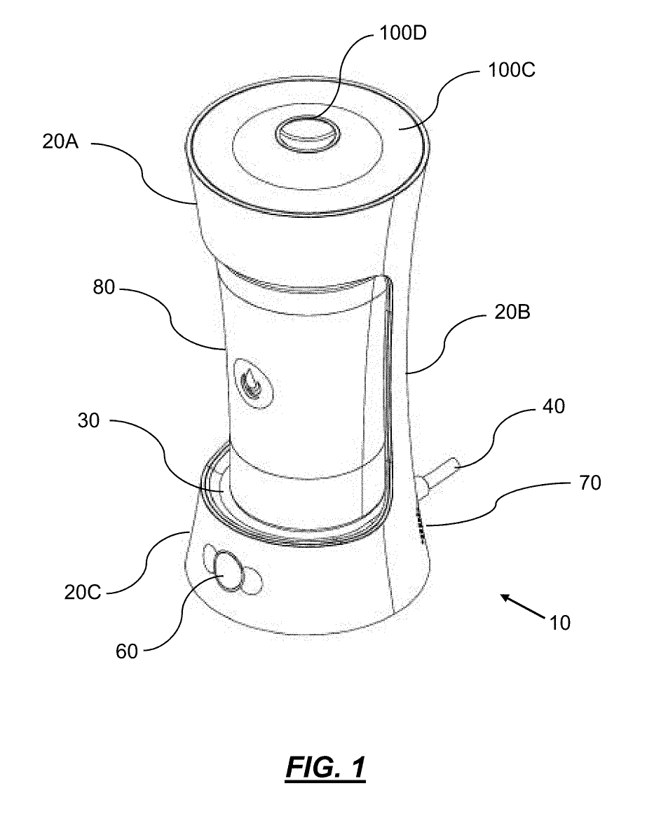

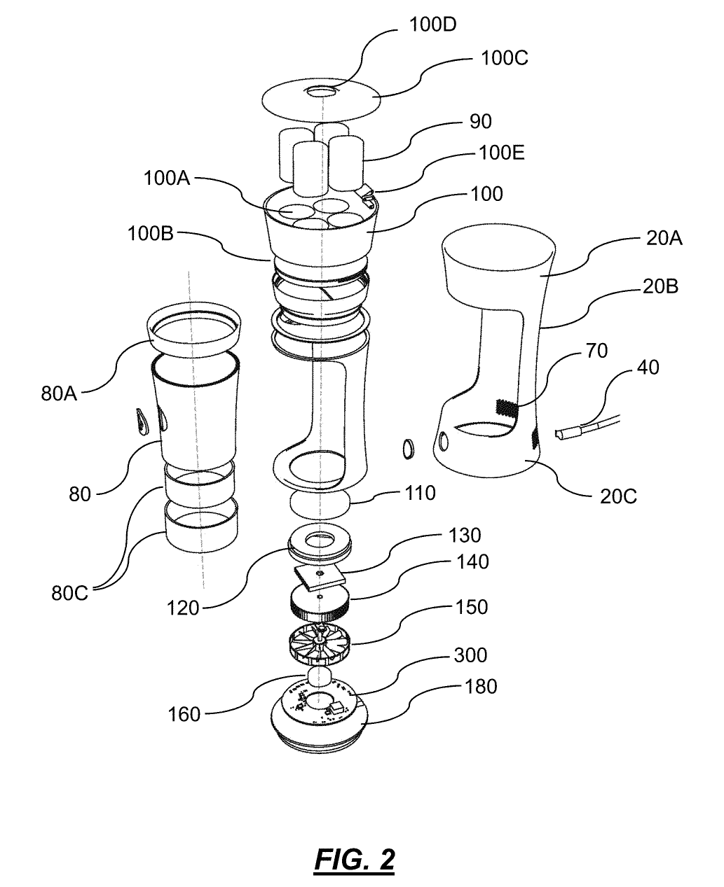

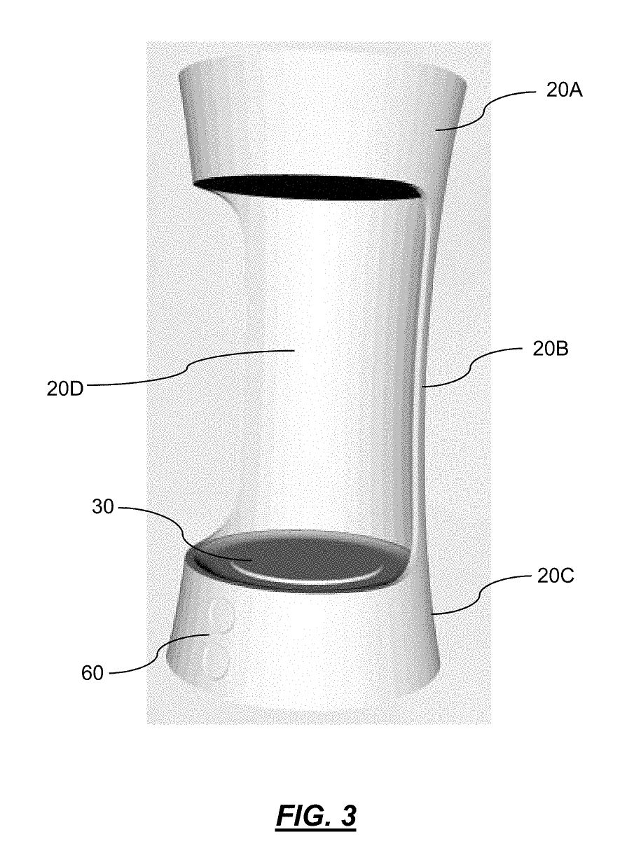

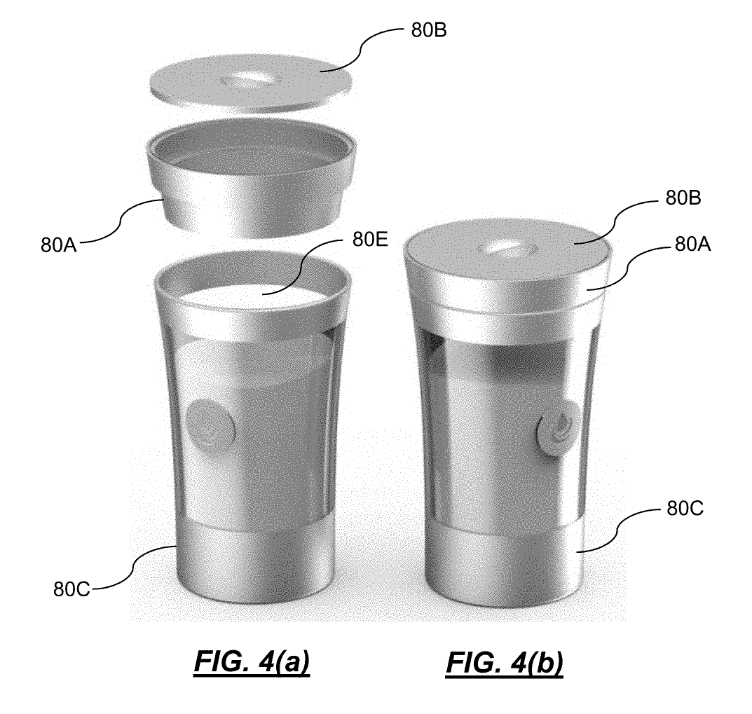

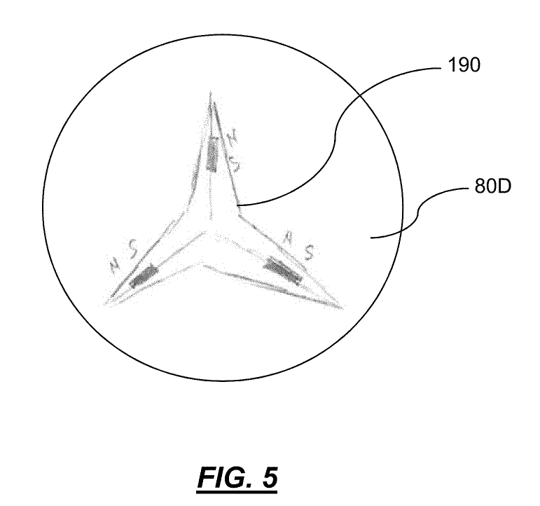

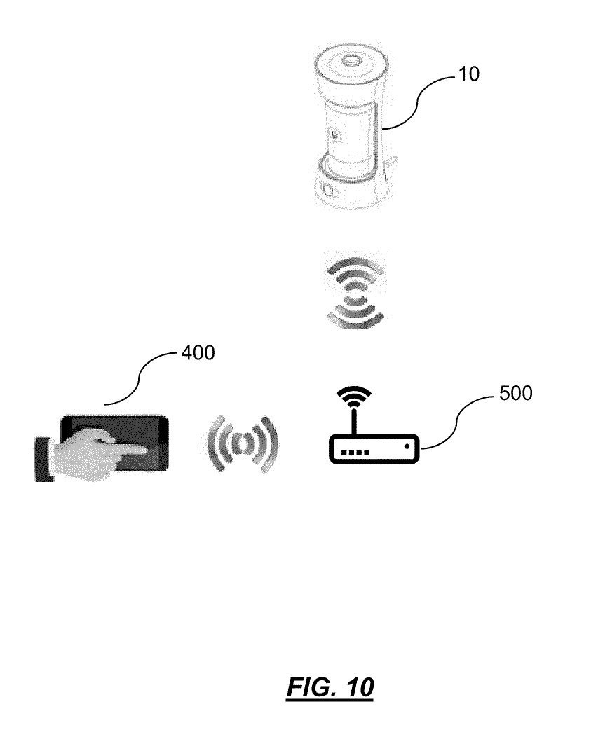

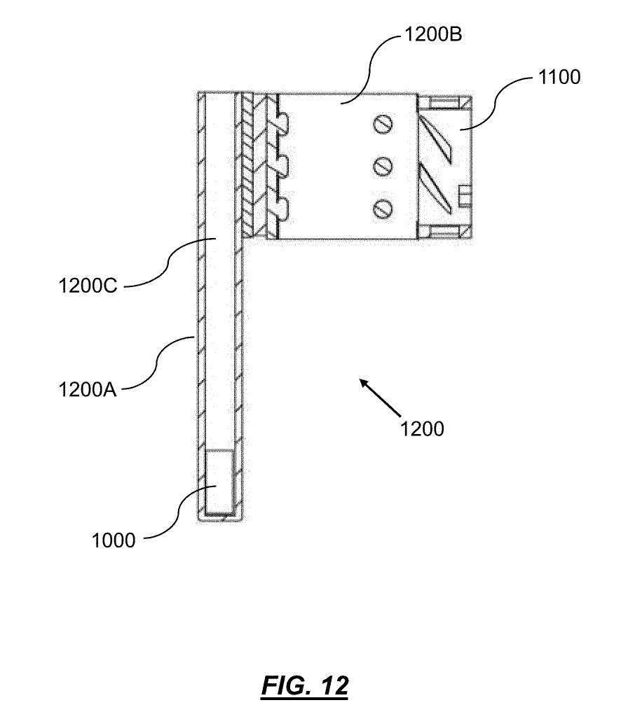

Preferred embodiments of the present invention will now be described herein with reference to FIGS. 1 to 13(b).

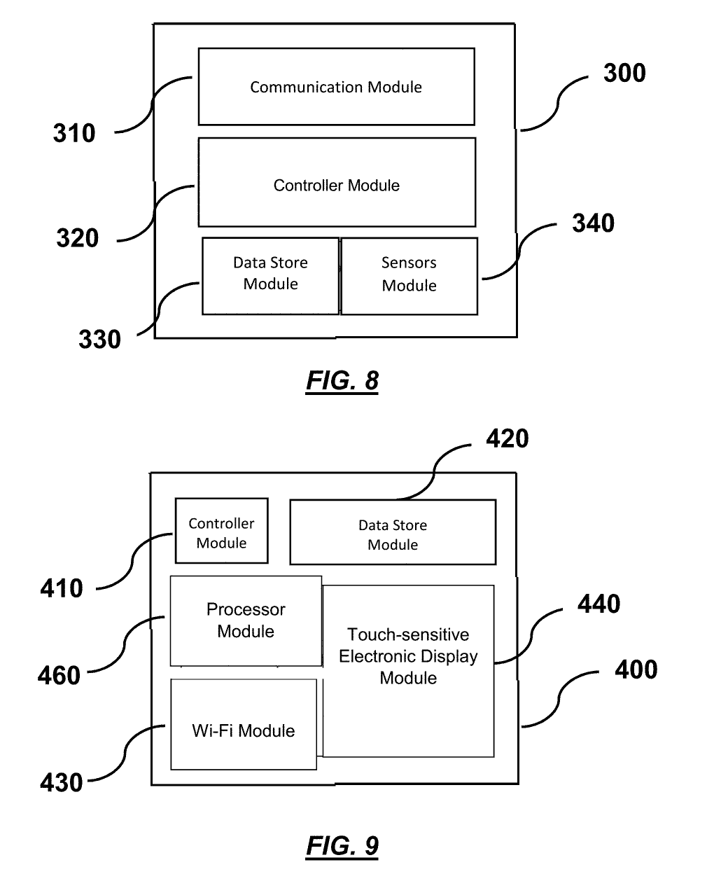

A first embodiment device (10) for making yoghurt is provided which comprises a base station (20A,20B,20C) having a reservoir (80) associated therewith for holding a yoghurt product pre-mixture, a stirrer (190) for stirring the yoghurt product pre-mixture within the reservoir (80), a temperature sensor module (340), a weight sensor (340) for sensing the presence of the yoghurt product pre-mixture in the reservoir (80), a heating device (130) operatively connected to the temperature sensor module (340) for heating the yoghurt product pre-mixture by reference to an output signal of the temperature sensor module (340), and, a cooling device (130) operatively connected to the temperature sensor module (340) for cooling the yoghurt product formed from the yoghurt product pre-mixture by reference to an output signal of the temperature sensor module (340). FIG. 8 shows a diagram of an aspect of a PCB (300) and it is understood that the sensors module (340) provides both the temperature sensor module and the weight sensor module functionality.

The base station (20A,20B,20C) may be molded from a thermoplastic material such as polypropylene or formed from a metal material which may provide suitable strength and heat resistance properties. The base station (20A,20B,20C) comprises a bottom section (20C), a top section (20A) and a middle section (20B). The bottom and top sections (20A,20C) of the base station (20A,20B,20C) include hollow regions configured for securely housing various electronic, mechanical and interconnective components of the device (10) such as the temperature sensor module, the heating device (130) and the cooling device (130).

In this embodiment, the reservoir (80) is comprised by a cup that may include a frame and base (80C) that are formed from a thermally conductive metal material, and, a sidewall comprising a thermoplastic material such as polypropylene which may be provide suitable strength and heat resistance properties. The sidewall of the reservoir cup (80) may comprise layers of thermoplastic material that are separated by air to provide insulation, or, in alternate embodiments may be formed from a transparent glass material. The reservoir (80) may typically have a capacity of up to around 500 ml. The middle section (20B) of the base station (20A,20B,20C) includes a recess (20D) shaped and dimensioned to removably receive the reservoir (80) therein. The reservoir (80) includes a lid (80B) which may be friction-fitted to a metal intermediate annular member (80A), which in turn is friction fitted to the opening (80E) of the reservoir (80). Before the reservoir (80) is located in the recess (20D) of the base station (20A,20B,20C) and sitting on top of the metal plate (30), the lid (80B) of reservoir (80) is first removed. When the reservoir (80) is removed from the recess (20D) of the base station (20A,20B,20C), for instance when a yoghurt product is formed in the reservoir (80), the lid (80B) may be attached to the opening of the reservoir cup (80) once again so that this conveniently provides an air-tight container for storing or transporting the yoghurt product.

In this embodiment, the functionality of the heating device (130) and the cooling device (130) are both provided by a single Peltier thermoelectric device (130) which is configured to create a heat flux between the junction of two different types of materials when a potential difference is provided between the two different types of materials. The Peltier thermoelectric device is located in the hollow region of the bottom section (20C) of the base station (20A,20B,20C) and is configured for thermal communication with the base of the reservoir (80C) via a metal plate (30) located at the bottom of the recess (20D) in the middle section (20B) of the base station (20A,20B,20C). Accordingly, when the reservoir (80) is removably received within the recess (20D) and sitting flush upon the metal plate (30) of the recess (20D) and the temperature in the reservoir (80) may be heated or cooled by selectably controlling operation of the thermoelectric Peltier device (130). The Peltier thermoelectric device (130) may be powered from a power supply of the device, for instance, via a cable (40) to a mains power supply. Advantageously, the use of a Peltier thermoelectric device (130) is convenient in that due to its relatively compact configuration and ability to perform both heating and cooling functions, it minimises the space within the bottom section (20C) of the base station (20A,20B,20C). A heat sink (140) is arranged in the bottom section (20C) of the base station (20A,20B,20C) and is arranged in thermal communication with the Peltier thermoelectric device (130) so as to dissipate heat from the device (10) during operation. A fan module (150) is also located within the bottom section (20C) between the heat sink (140) and the PCB (300) which is rotatably driven by a DC electric motor (160) to assist in evacuating ambient air heated by the heat-sink (140) within the hollow region of the bottom section (20C) out of the bottom section (20C) of the base station (20A,20B,20C) via an air vent (70) disposed in a sidewall of the base station (20A,20B,20C). The speed and operation of the DC electric motor is controlled by a microcontroller module (320) disposed on the PCB (300). With evacuation of the heated ambient air out of the bottom section (20C) via the air vent (70), relatively cooler air is then able to flow into the bottom section (20C) via the air vent (70) to alleviate overheating of the device (10).

It would be appreciated that in alternate embodiments of the present invention, heating and cooling functions may be provided by use of different mechanisms. For instance, the heating device function could be implemented using a coiled resistive wire which is heated by using the power supply of the device to provide an electric current through the coil. The coiled resistive wire may similarly be in thermal communication with the reservoir (80) via the metal plate (30) in the bottom of the recess (20D).

The heating and cooling devices (130) are operatively connected to a temperature sensor module (340) which is configured for sensing the temperature of the yoghurt product pre-mixture and formed yoghurt product within the reservoir (80) during the yoghurt making process. The heating and cooling device (130) is configured for maintaining controlled heating and cooling by reference to an output signal from the temperature sensor module (340).

The stirrer (190) is comprised by a magnetic stirrer mechanism having a stirring element (190) that is movably mounted within the reservoir (80) upon an inner bottom surface (80D) of the reservoir (80), and, a permanent magnet device that is rotatably movable within the bottom section (20C) of the base station (20A,20B,20C) by a DC electric motor (160). When power is supplied to the DC electric motor (160) it rotates the permanent magnet beneath the metal plate (30) of the recess (20D). As the permanent magnet is magnetically coupled to the stirring element (190) within the reservoir (80) sitting upon metal plate (30), the stirring element (190) will be caused to rotate within the reservoir (80) with movement of the permanent magnet to produce the stirring effect. It would be appreciated that in alternate embodiments of the present invention, it may be possible to utilise an electromagnetic device configuration within the bottom section (20C) of the base station (20A,20B,20C) in order to actuate rotational movement of the stirrer (190) about the reservoir (80), instead of a motorised permanent magnetic. However, the implementation of an electromagnetic device configuration would require additional control circuitry and wiring.

The yoghurt product pre-mixture includes an effective amount of a milk constituent (such as a full-cream milk non-pasteurised milk constituent), a yoghurt culture constituent (such as an effective amount of a live yogurt or a dried starter culture), and a flavour constituent. In this embodiment, both the yoghurt culture constituent and the flavour constituent are provided in the form of compressed powder tablets (90) although these may be implemented in a liquid form instead.

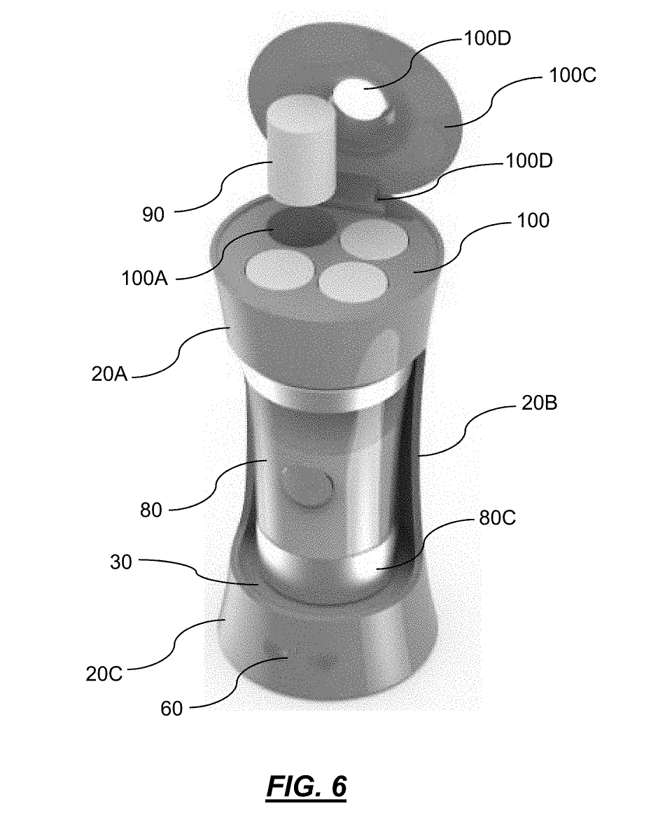

A dispenser (100) is located in the top section (20A) of the base station (20A,20B,20C) comprising a cylindrical shaped holder (100) having a plurality of receptacles (100A) disposed therein for releasably holding the various yoghurt culture constituent and flavour constituent compressed powder tablets (90). These compressed powder tablets (90) are able to be controllably dispensed from the receptacles (100A) in the holder (100) into the reservoir (80) via the opening (80E) of the reservoir (80) positioned beneath the dispenser (100) in the recess (20D) of the middle section (20B) of the base station (20A,20B,20C). As can be seen, the compressed power tablets (90) are received into the receptacles (100A) from an upper-facing side of the holder (100) when the lid (100C) of the base station (20A,20B,20C) is rotated about a hinge (100E) into an opened position as shown in FIG. 6. Conveniently, the lid (100C) includes a finger-engagement portion (100D) for ease of gripping of the lid (100C) when rotating the lid (100C) about the hinge (100E). Each of the receptacles (100A) also have openings in a reverse lower-facing side of the holder (100) to allow the compressed tablets (90) received within the receptacles (100A) to slide through the receptacle (100) from the upper-facing side and out of the receptacle (100) via the openings in the lower-facing side of the holder (100) by the force of gravity. A circular-shaped blocking plate (100B) abuts flush against the lower-facing side of the holder (100) to controllably block exit of the compressed powder tablets (90) via the openings in the receptacles (100A) in the lower-facing side of the holder (100). The blocking plate (100B) includes a blocking plate opening that is shaped and dimensioned to match the openings of the receptacles (100A) on the lower-facing side of the holder (100). By rotating the blocking plate (100B) relative to the holder (100), the blocking plate opening may be selectably aligned with any one of the openings of the receptacles (100A) on the lower-facing side of the holder (!00) whereby the compressed powder tablet (90) in the corresponding receptacle (100A) may freely drop through the aligned receptacle (100A) opening and blocking plate (100B) opening and into the reservoir (80).

In this embodiment, the blocking plate (100B) is rotatably movable by an electromagnetic actuator mechanism disposed between the blocking plate (100B) and the holder (100). The electromagnetic actuator mechanism is operably connected with a microcontroller module disposed on the PCB (300) which is configured for controlling operation of the electromagnetic actuator mechanism so that the blocking plate opening and the opening in the receptacles may be suitably aligned to allow for dispensing of the correct compressed powder tablet(s) in accordance with the user selection of the type of yoghurt to be produced, The electromagnetic actuator mechanism is also operable connected to the power supply accessible via the bottom section (20C) of the base station (20A,20B,20C) via electrical bus wiring running through the sidewall of the base station form the top section (20A) to the bottom section (20C).

The device (10) includes a controller module such as a microcontroller module disposed on the PCB (300) that is configured for controlling operation of the dispenser (100), the stirrer (190), the temperature sensor module (340), the heating device (130), and the cooling device (130) in accordance with predefined operational mode settings for producing different types of yoghurt products (e.g. set yoghurt, Greek yoghurt, stirred yoghurt). The microcontroller module is disposed on the PCB (300) together with a data store module that is communicably connected with the microcontroller module. The data store (330) stores data indicative of the different predefined operational mode settings and such data when accessed by the microcontroller module allows the microcontroller module to control operation of each of the various components of the device to process the production of the yoghurt product by reference to the predefined operational mode settings. In certain embodiments, the data store may include a server-side data store or a cloud-based data store that are communicably connected with a communication module of the device via respective a communication network such as a local-area-network, a wide-area-network or the Internet, by way of example, whereby the microcontroller module is able to access data indicative of predefined operational mode settings stored therein.

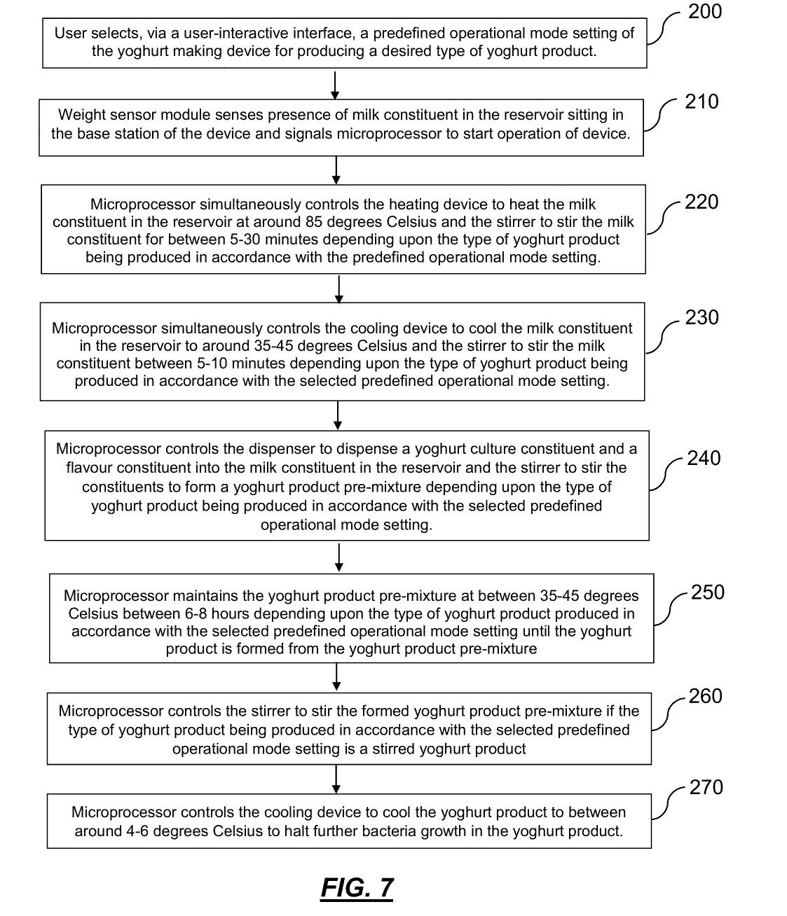

By way of example, once the user has selected via the user-interactive interface a predefined operational mode setting of the yoghurt making device (10) for producing a desired type of yoghurt product (as represented by block (200) in FIG. 7), the microcontroller module may operate the various components of the device (10) as follows:
(i) a weight sensor module (340) senses the presence of milk constituent in the reservoir (80) sitting in the base station (20A,20B,20C) of the device (10) and signals microcontroller module (320) in the PCB (300) to start operation of device (10). This step is represented by block (210) in FIG. 7;
(ii) thereafter, the microcontroller module (320) disposed in the PCB (300) simultaneously controls the heating device (130) to heat the milk constituent in the reservoir (80) around 85 degrees Celsius and controls the magnetic stirrer (190) to stir the milk constituent for between 5-30 minutes depending upon the type of yoghurt product being produced in accordance with the predefined operational mode setting. This step is represented by block (220) in FIG. 7;
(iii) thereafter, the microcontroller module (320) in the PCB (300) simultaneously controls the cooling device (130) to cool the milk constituent in the reservoir (80) to around 35-45 degrees Celsius and controls the magnetic stirrer (190) to stir the milk constituent between 5-10 minutes depending upon the type of yoghurt product being produced in accordance with the selected predefined operational mode setting. This step is represented by block (230) in FIG. 7;
(iv) thereafter, the microcontroller module (320) in the PCB (300) controls the dispenser (80) to dispense a yoghurt culture constituent and a flavour constituent into the milk constituent in the reservoir (80) and the magnetic stirrer (190) to stir the constituents to form a yoghurt product pre-mixture depending upon the type of yoghurt product being produced in accordance with the selected predefined operational mode setting. This step is represented by block (240) in FIG. 7;
(v) thereafter, the microcontroller module (320) in the PCB (300) maintains the yoghurt product pre-mixture at between 35-45 degrees Celsius between 6-8 hours depending upon the type of yoghurt product produced in accordance with the selected predefined operational mode setting until the yoghurt product is formed from the yoghurt product pre-mixture. This step is represented by block (250) in FIG. 7;
(vi) thereafter, the microcontroller module (320) in the PCB (300) controls the magnetic stirrer (190) to stir the formed yoghurt product pre-mixture if the type of yoghurt product being produced in accordance with the selected predefined operational mode setting is a stirred yoghurt product. This step is represented by block (260) in FIG. 7; and
(vii) thereafter, the microcontroller module (320) in the PCB (300) controls the cooling device (130) to cool the yoghurt product to between around 4-6 degrees Celsius to halt further bacteria growth in the yoghurt product. This step is represented by block (270) in FIG. 7.

It will be appreciated that the above process steps are indicative of only one predefined operational mode setting of the device (10) for illustrative purposes. Other exemplary predefined operational mode settings may configured to perform at least some of the actions/steps as summarised in the Table 1 as follows.

TABLE 1
Steps/Actions of Exemplary Predefined Operational Modes

| | | | | | MICONTROLLER |
|---|---|---|---|---|---|
| | | | | | MODULE |
| TIMING | USER | GREEK | PLAIN | STIRRED | FIRMWARE |
| STEPS | ACTION | YOGHURT | YOGHURT | YOGHURT | TASKS |
| 1. | User adds | | | | |
| | milk in to the | | | | |
| | reservoir | | | | |
| 2. | User inserts | | | | Weight sensor |
| | reservoir in to | | | | (e.g. load cell) |
| | the recess of | | | | operatively |
| | the base | | | | connected to the |
| | station | | | | microcontroller |
| | | | | | module (320) |
| | | | | | senses presence |
| | | | | | of the reservoir |
| | | | | | and milk and |
| | | | | | microcontroller |
| | | | | | module starts |
| | | | | | operation of the |
| | | | | | device (10). |
| 3. | User inserts | | | | |
| | the | | | | |
| | compressed | | | | |
| | power tablets | | | | |
| | in to the | | | | |
| | recesses of | | | | |
| | the dispenser | | | | |
| 4. | User | Magnetic | Magnetic | Magnetic | Microcontroller |
| | activates | stirrer starts | stirrer starts | stirrer starts | controls the DC |
| | | stirring the | stirring the | stirring the | motor to effect |
| | | milk | milk | milk | rotational |
| | | constituent in | constituent in | constituent in | movement of the |
| | | the reservoir | the reservoir | the reservoir | permanent magnet |
| | | | | | at 50% maximum |
| | | | | | rotational speed. |
| 5. | | Start heating | Start heating | Start heating | Start the heating |
| | | device to heat | device to heat | device to heat | device and adjust |
| | | the milk | the milk | the milk | heating device |
| | | constituent | constituent | constituent | setting by |
| | | and maintain | and maintain | and maintain | reference to |
| | | temperature | temperature | temperature | temperature |
| | | at around 85 | at around 35 | at around 35 | sensor module |
| | | degrees for | degrees for | degrees for | signal |
| | | 20 min | 20 min | 20 min | |
| 6. | | Continue to | Continue to | Continue to | Start the Peltier |
| | | stir and start | stir | stir | thermoelectric |
| | | cooling to 35 | | | device to cool, |
| | | degrees | | | check the |
| | | | | | temperature to |
| | | | | | bring down to 35 |
| | | | | | degrees, start the |
| | | | | | fan attached to |
| | | | | | heat sink to |
| | | | | | remove the heat |
| 7. | | Dispense the | Dispense the | Dispense the | Microcontroller |
| | | yoghurt | yoghurt | yoghurt | controls the |
| | | culture | culture | culture | electromagnetic |
| | | constituent | constituent | constituent | actuator to |
| | | and the | and the | and the | rotationally move |
| | | yoghurt | yoghurt | yoghurt | the blocking plate |
| | | flavour | flavour | flavour | relative to the |
| | | constituent | constituent | constituent | holder of the |
| | | into the | into the | into the | dispenser. |
| | | reservoir from | reservoir from | reservoir from | |
| | | the dispenser | the dispenser | the dispenser | |
| | | holder. | holder. | holder. | |
| 8. | | Magnetic | Magnetic | Magnetic | Microcontroller |
| | | stirrer stirs the | stirrer stirs the | stirrer stirs the | stops the magnetic |
| | | yoghurt | yoghurt | yoghurt | stirrer |
| | | product pre- | product pre- | product pre- | |
| | | mixture in the | mixture in the | mixture in the | |
| | | reservoir for 1 | reservoir for 1 | reservoir for 1 | |
| | | minute | minute | minute | |
| 9. | | Maintain the | Maintain the | Maintain the | Microcontroller |
| | | temperature | temperature | temperature | controls the |
| | | at around 35 | at around 35 | at around 35 | heating device to |
| | | degrees | degrees | degrees | maintain the |
| | | Celsius for 6 | Celsius for 6 | Celsius for 6 | temperature of the |
| | | hours | hours | hours | yoghurt product |
| | | | | | pre-mixture at 35 |
| | | | | | degrees for 6 |
| | | | | | hours and checks |
| | | | | | the temperature |
| | | | | | every 30 min. |
| 10. | | | | Magnetic | Microcontroller |
| | | | | stirrer stirs the | controls the DC |
| | | | | formed | motor to operate at |
| | | | | yoghurt | 100% speed to |
| | | | | product in the | effect rotation of |
| | | | | reservoir for 5 | the magnetic |
| | | | | minutes to | stirrer for 10 |
| | | | | form stirred | minutes |
| | | | | yoghurt | |
| 11. | | Cooling | Cooling | Cooling | Microcontroller |
| | | device starts | device starts | device starts | stops operation of |
| | | cooling the | cooling the | cooling the | the heating device |
| | | yoghurt | yoghurt | yoghurt | and starts |
| | | product in the | product in the | product in the | operation of the |
| | | reservoir to | reservoir to | reservoir to | cooling device |
| | | between | between | between | embodied by the |
| | | around 9-12 | around 9-12 | around 9-12 | Peltier |
| | | degrees | degrees | degrees | thermoelectric |
| | | | | | device to full |
| | | | | | current; |
| | | | | | Microcontroller |
| | | | | | checks the |
| | | | | | temperature of the |
| | | | | | yoghurt product in |
| | | | | | the reservoir every |
| | | | | | 30 minutes and |
| | | | | | maintain about 10 |
| | | | | | degree (turn off the |
| | | | | | Peltier |
| | | | | | thermoelectric |
| | | | | | device every 30 |
| | | | | | minutes for 5 |
| | | | | | minutes to save |
| | | | | | energy and |
| | | | | | preserve the |
| | | | | | lifespan of the |
| | | | | | Peltier |
| | | | | | thermoelectric |
| | | | | | device); and starts |
| | | | | | rotation of the |
| | | | | | cooling fan driven |
| | | | | | by the DC motor to |
| | | | | | evacuate heated |
| | | | | | ambient air |
| | | | | | proximate to the |
| | | | | | heat sink out of the |
| | | | | | air vent. |

A user-interactive interface is provided via which a user is able to select a particular predefined operational mode of the device to produce a corresponding style of yoghurt. The user-interactive interface includes a control switch (60) disposed on the device (10) which is operable amongst a plurality of operational states. The microprocessor (320) disposed on the PCB (300) is operably connected to the control switch (60) and configured to detect the operational state of the control switch (60) and to thereby operate the device (10) in accordance with predefined operational settings pre-associated with corresponding to the operational state of the control switch (60) selected by the user. The control switch may include an electronic switch, a control knob by way of example. In response to the control switch (60) being actuated into each of the different operational states, a transducer may output unique electrical signals to the microprocessor (320) disposed on the PCB (300) indicative of the different operational states of the control switch (60). Thereafter, the microprocessor (320) disposed on the PCB (300) is programmed to operate each of the components of the device in accordance predefined operational mode settings that are pre-associated with the difference received transducer electrical signals.

The user-interactive interface may also be embodied by remote electronic control (400) configured for wireless communication with a communication module (310) of the device (10), for instance, via a wireless home network. Typically, the wireless communication link may include at least one of a Wi-Fi or a Bluetooth protocol based communication link. The remote electronic device (400) could include a smartphone, a tablet-type device or a portable computer.

Referring to FIGS. 7-10, a computerised system is shown whereby a user may conveniently use a smartphone (400) to remotely operate the yoghurt-making device (10) described above. Referring to FIG. 8, a functional block diagram of one aspect of the PCB (300) of the yoghurt-making device (10) is shown which includes a Wi-Fi communication module (310) for wireless protocol communication with the smartphone (400) via a Wi-Fi router (500), a data store (330) for storing the predefined operational mode settings for producing different types of yoghurt, and the microprocessor module (320) for controlling the device (10) in accordance with the different operational mode settings to produce the different varieties of yoghurt. The smartphone (400) includes a Wi-Fi communication module (430) via which it can communicate with the communication module (310) of the yoghurt maker device (10) via the WI-FI router (500). In this embodiment, at least some of the functional components of the system are integrally embodied in the smartphone (400) which serves as the primary controller of the yoghurt-making device (10). However, it would be appreciated that some of the functional components of the computerised system may be embodied in a distributed computerised system whereby certain control and processing functions may be performed partially or entirely externally of the smartphone (400) and the yoghurt-making device (10), for instance via a cloud or server-side type processor operably connected to the smartphone (400) and yoghurt-making device (10) via a communication network, such as the Internet or a home or office network.

The smartphone (400) includes a touch-sensitive electronic display module (440) which functions as both an output display module and also as the graphical user-interface module (440) for inputting user commands to remotely control operation of the yoghurt-making device (10). It is of course possible in alternate embodiments for the input module to be a separate input device such as a physical keypad, touchpad or mouse type device interface. A software application module is downloadable into the data store module (420) of the smartphone (400) from an online computer server via the communication network and is executable by the processor module (460) of the smartphone (400) to function as the input graphical user-interface (440). The software application module is further configured to allow operable connection of the smartphone (400) with the yoghurt-making device (10) via the respective communication modules (430,310). In alternate embodiments, the various user-interactive control provided by the software application module may be implemented by embedded software disposed in the hardware itself or any other suitable hardware technology.

The interactive graphic user interface (440) displays a plurality of selectable interactive icons representing the different predefined operational mode settings of the yoghurt-making device (10). Upon sensing of selection of an interactive icon via the touch-sensitive electronic display module (440), the processor module (460) of the smartphone (400) communicates an instruction to the microprocessor (320) of the yoghurt-making device (10) which, responsive to receipt of the instruction, operates the yoghurt-making device (10) in accordance with the corresponding predefined operational mode settings to effect production of the type of yoghurt selected by the user. The microprocessor module (320) is also configured to communicate a signal to the user-interactive interface to output a notification to the user that is indicative of completion of the yoghurt marking process in accordance with the predefined operational mode settings. Such a notification may simply include any one of a flashing LED located on the device (10), an audible alert, or a text message displayed on the graphical-user interface of the application software running on the smartphone (400), by way of example.

The microcontroller module (320) is further configured to control the components of the device (10) to operate in accordance with one predefined operational mode which is a self-cleaning operational mode. In performing this mode, the user may first add water into the reservoir (80) and place it in the recess (20D) of the base station (20A,20B,20C), then enter a command via the user-interactive interface (i.e. either the control switch (60) or via the smartphone (400)) to commence operation of the self-cleaning cycle. Thereafter, in response to detection of the control signal from the user-interactive interface, the microcontroller module (320) simultaneously controls the heating device (130) to heat the water in the reservoir (80) to a temperature of approximately 80 degrees Celsius and controls the magnetic stirrer (190) to stir and agitate the water within the reservoir (80). This results in residue within the reservoir from being washed out of regions of the reservoir which may be relatively hard to access via manual cleaning. The microcontroller module (320) controls the heating device (130) and the magnetic stirrer (190) to operate for a duration of around 7 minutes before the self-cleaning cycle is completed. The microcontroller module (320) regulates the temperature of the water in the reservoir (80) at the requisite temperature by periodically reading an output sensor signal from the temperature sensor module (340) operably connected to the microcontroller module (320) which is in thermal communication with the reservoir (80) via the metal base of the reservoir (80). The output sensor signal from the temperature sensor module (340) is indicative of the temperature of the water within the reservoir (80) sensed by the temperature sensor module (340). In response to the temperature indicated by the output sensor signal, the microcontroller module (320) may operate the heating device or cooling device (130) to result in an increase or decrease in the water temperature as required so that the water temperature remains at approximately 80 degrees Celsius.

In addition to adding water to the reservoir (80), an amount of an organic detergent may also be added to the water in the reservoir (80) as well during the self-cleaning cycle. By way of example, the organic detergent may be also formed as a compressed powder tablet that may be inserted in to one of the receptacles (100A) from where it may be automatically dispensed into the reservoir (80) from the receptacle (100A) in a similar manner as described earlier in the description. In this embodiment, the organic detergent compressed powder tablet is automatically dispensed into the water in the reservoir (80) at around 3 minutes into the overall 7-minute cleaning cycle duration. After completion of the cleaning cycle, a notification is output via the user-interactive interface to indicate that the cycle has completed. The notification may be effected by way of an audible beeping sound and/or an LED light device emission from the device (10) and/or by way of a text message notification being communicated to the remote controller smartphone user-interactive interface.

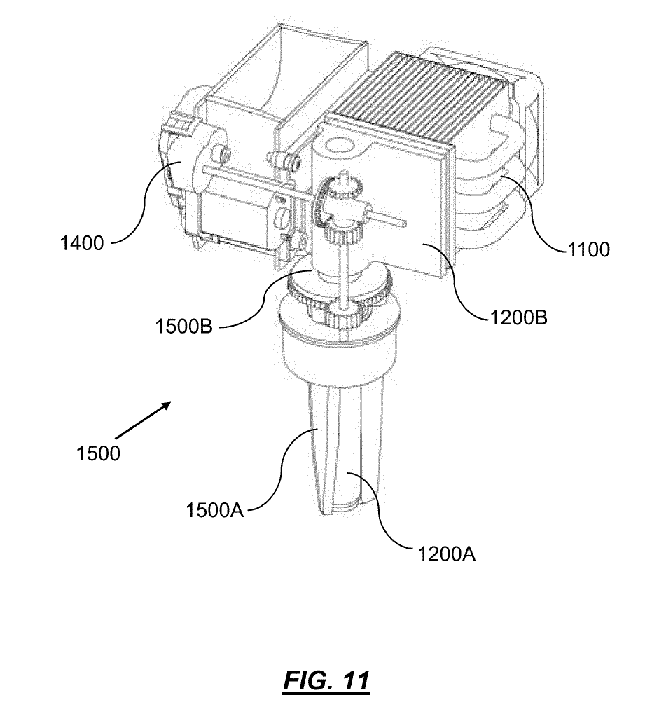

Referring now to FIGS. 11, 12 and 13(a)-13(b), further embodiments of the present invention are depicted in which the heating and cooling may be driven by separate heating and cooling devices (1000,1100) which may assist in providing more effective heating and cooling functionality than may otherwise be provided by certain dual-purpose heating/cooling device. Both the heating and cooling devices may be powered by a common power source such as a battery module, or by a main power supply via suitable power interfacing circuitry. In certain such further embodiments, both the cooling device and the heating device (1000,1100) may be arranged in thermal communication with a common heat transfer element (1200) via which heat is able to be transferred in to or out of the yoghurt product pre-mixture by the heating and cooling devices (1000,1100). By way of example, the heat transfer element (1200) may be mounted adjacent to a top section of the base station and may include a first region (1200A) that is configured for extending downwardly from the top section of the base station into the yoghurt product pre-mixture within the reservoir (1300) when the reservoir (!300) is received in the base station recess. A second region (1200B) of the heat transfer element (1200) includes a substantially planar contact surface for contacting with the cooling device (1100) such as a thermoelectric Peltier type cooling device. In this embodiment, the first region (1200A) may be configured as an elongate probe whilst the second region (1200B) may be configured as a substantially flat plate upon which the thermoelectric cooling device (1100) may lie flush against. The first and second regions (1200A,1200B) of the heat transfer element (1200) are integrally formed from a single thermally conductive material such as metal or the like although it is conceivable that the first and second regions (1200A,1200B) may be formed separately and joined together during assembly of the embodiment device.

In these further embodiments, the heating device (1000) comprises a rod-shaped configuration (1000) which is configured for thermal communication with a third region (1200C) of the heat transfer element (1200) comprising a hollow recess (1200C) extending downwardly into and along a length of the heat transfer element (1200). The hollow recess (1200C) is suitably shaped and dimensioned to complement the shape configuration of the rod-shaped heating device (1000) received therein and to provide for effective thermal communication between the heating device (1000) and the heat transfer element (1200). In this embodiment, the heating device (1000) may for instance include any one of a metallic heating device, a ceramic heating device, a polymer heating device or any combination thereof. The heating device (1000) is configured for releasable insertion into and out of the hollow recess (1200C) of the heat transfer element (1200) so as to extend along a length of the heat transfer element (1200) when in contact with the yoghurt product pre-mixture within the reservoir (1300). This assists in maximising efficiency in the transfer of heat into the yoghurt product pre-mixture via the heat transfer element (1200). Advantageously, the heating device (1000) in accordance with this embodiment is able to raise the temperature of the yoghurt product pre-mixture within the reservoir (1300) to around 85 degrees Celsius which is the optimal temperature by which cross-linking and thickening of the constituents within the yoghurt product pre-mixture takes place.

In this further embodiment, the cooling device (1100) is also configured to serve a dual-purpose as the stirrer for stirring the yoghurt product pre-mixture within the reservoir (1300). In this regard, a single DC electric motor (1400) may be mechanically interfaced with both stirrer (1500) and the dispenser to drive both devices. In this embodiment, the stirrer (1500) comprises a stirrer tool head (1500A) that is releasably attachable to the first region (1200A) of the heat transfer element (1200). For instance, the stirrer tool head (1500A) may be configured for slide-fitting over an end of the first region (1200A) of the heat transfer element (1200). The stirrer tool head (1500A) may be maintained in releasable attachment with the first region (1200A) of the heat transfer element (1200) by use of magnetic attachment elements located in the stirrer tool head (1500A) and/or located in the first region (1200A) of the heat transfer element (1200). The magnetic attachment elements are of suitable magnetic field strength so as to maintain the stirrer tool head (1500A) in a fixed relative position to the first region (1200A) of the heat transfer element (1200) as the first region (1200A) of the heat transfer element (1200) is rotated by the DC electric motor (1400). The stirrer tool head includes a plurality of tapered stirrer blades extending radially outwardly from the stirrer tool head (1500A) as shown in the drawings. Conveniently, the releasable attachability of the stirrer tool head (1500A) may allow for ease of cleaning, repair or replacement of the stirrer blade if so required. Of course, in other embodiments, the stirrer tool head need (1500A) not be releasably attachable and may comprise an attachment that remains fixed to the first region (1200A) of the heat transfer element (1200). Yet further, the heat transfer element (1200) and the stirrer (1500) may be comprised by separate devices however it is considered that the implementation of this dual-purpose heat transfer element/stirrer configuration may provide several advantages including for instance, economy of space, as well as assisting in effecting improved heat distribution within the yoghurt product pre-mixture, and alleviation of localised over-heating of the yoghurt product pre-mixture at regions within the yoghurt product pre-mixture adjacent to the heating device (1000), and alleviating build-up of milk skin on the stirrer tool head (1500A) (which would otherwise necessitate manual cleaning and maintenance to facilitate effective cooling and heating). The stirrer may for instance be driven by any suitable mechanical, pneumatic, hydraulic or magnetic drive mechanism. Alternately, in certain embodiments, the stirrer tool head may be configured to rotate about the second region of the heat transfer element (which remains stationary). In such embodiments, the stirrer tool head may be magnetically or otherwise mechanically coupled to the second region of the heat transfer element but configured to rotate about the second region of the heat transfer element (1200) without detaching from the heat transfer element (1200). As shown in this example, a geared assembly with output shafts are mechanically coupled to the stirrer tool head (1500A) which rotate the stirrer tool head (1500A) independently of the stationary heat transfer element (1200). Of course, the geared assembly (1500B) and output shafts may be coupled to the heat transfer element (1200) to rotate it together with the stirrer tool head (1500A).

In accordance with this embodiment, the reservoir (1300) does not sit directly upon the base metal plate as in the case of the earlier-described embodiments. Instead, a ring-shaped reservoir holder (1600) is mounted to the base station and configured to extend into the recess of the base station whereby it releasably engages with the reservoir (1300) so as to suspend the reservoir (1300) above the base within the recess of the base station. The ring-shaped reservoir holder (1600) may releasably engage with the rim (1300A) by any one of a clamping, clipping, friction-fitting, bayonet-fitting type connection or other suitable engagement mechanism. The reservoir holder (1600) may also be configured to releasably engage with other portions of the reservoir (e.g. circumferentially around the main body of the reservoir) not necessarily being the rim of the reservoir (1300).

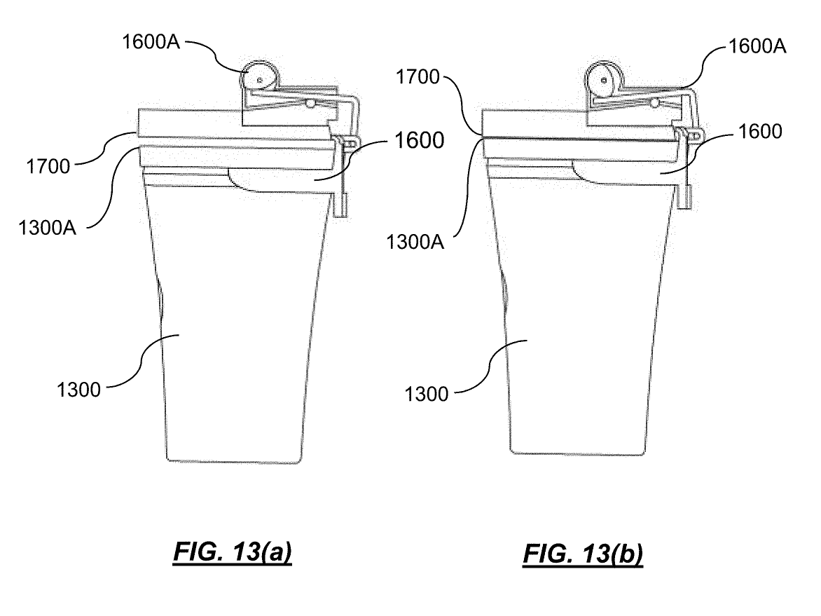

In accordance with this embodiment, an automatic venting module is provided to enhance for water vapour to be vented from the reservoir (i.e. water vapour that has been released from the yoghurt product pre-mixture into the reservoir during the heating stage). The controller module may be operably-connected with the venting module and programmed so as to automatically control the venting operation of the venting module when the controller module receives an output signal from the temperature sensor module indicating that the temperature of the yoghurt product pre-mixture in the reservoir has reached approximately around 85 degrees Celsius. In this embodiment, the venting module includes the reservoir holder (1600) which is configured for sliding movement upward and downward within the base station recess. The controller module is programmed and calibrated so that it controls a mechanical means (1600A) (i.e. in this example comprising a cam and lever assembly) for moving/positioning the reservoir into its default position (as shown in FIG. 13(b)) at the commencement of the heating stage, whereby, the gap between the rim (1300A) of the reservoir and the top section (1700) of the base station is set at a relative minimum distance. Thereafter, during operation of the device, when controller module receives the temperature sensor output signal indicating that the temperature of the yoghurt product pre-mixture has reached 85 degrees Celsius, the controller module is programmed to control the venting module to commence venting of the water vapour. That is, the controller module signals the mechanical means (1600A) to slide the reservoir holder (1600) downwardly together with the reservoir (1300) a predefined distance until the gap between the rim (1300A) of the reservoir (1300) and the top section (1700) of the base station is a relative maximum (as shown in FIG. 13(a)). The reservoir (1300) is held in this venting position for a predetermined period of time before the controller module then controls the mechanical means (1600A) of the venting module to slide the reservoir (1300) back in to its initial default position. In alternate embodiments, the venting module may be implemented using alternate mechanisms. For instance, the reservoir (1300) may be configured to rest upon a platform which is slidable upwardly and downwardly within the base station recess. The sliding movement of the reservoir (1300) may be effected using any suitable mechanical, magnetic, hydraulic and/or pneumatic driving mechanism without limitation, and further, may not necessarily be configured to slide the reservoir upwardly and downwardly within the recess of the base station, but may also be configured to move the reservoir (1300) in other orientations such as by tilting or rotating the reservoir (1300) within the recess. In certain embodiments, the main body of the reservoir (1300) may be maintained in a relatively stationary position whilst a venting member disposed on the reservoir may be controllably moved to allow for venting of the excess water vapour from the reservoir. Conveniently, the venting of the excess water vapour as described above results in a yoghurt product being produced which is relatively thicker consistency and relatively less watery than would be the case without venting.

It would be appreciated that in any of the embodiments described herein, additionally and/or alternatively to using a proximity or weight sensor for sensing the presence and amount of yoghurt product pre-mixture (i.e. milk, yoghurt culture, flavouring and other/or constituents) in the reservoir, this sensing function may be performed by way of capacitive sensing or based upon temperature readings sensed by the temperature sensor module operably-connected with the heating device and cooling device. For instance, when the reservoir is placed in the recess of the base station, and the heat transfer element extends downwardly in to contact with the yoghurt product pre-mixture within the reservoir, the temperature reading sensed by the temperature sensor module will change measurably. Yet further, it is possible that an infra-red distance sensor, ultrasonic sensor, pressure and/or ambient humidity sensor instead to assist in approximating the stage of processing of the yoghurt product pre-mixture in the reservoir based on water content, distance, pressure, humidity, weight, temperature or any other measurable and reasonably consistent and predictable characteristic of the yoghurt product pre-mixture during the yoghurt making process.

In view of the above, it will be apparent that embodiments of the present invention described herein may assist in providing various advantages. For instance, by providing a separate heating device and a cooling device to drive heating and cooling within the yoghurt making device, optimal temperatures may be achieved to produce a yoghurt of suitably rich and thick texture and quality. This also alleviates the need to transfer the yoghurt product pre-mixture between separate reservoirs during the heating and cooling stages as embodiments may utilise separate heating and cooling devices to suitably perform heating and cooling of the yoghurt product pre-mixture within a common reservoir. Further, embodiments of the present invention involve the use of devices that are relatively compact and portable in size in the context of home appliances and now allows smaller non-commercial scale quantities of yoghurt to be produced without the need for bulky and expensive equipment suitable for bulk commercial production. Yet further, the yoghurt product that is produced in accordance with embodiments of the present invention may have a relatively richer and thicker texture and quality not only due to the separate heating and cooling devices utilised, but also, by virtue of the inclusion of a venting mechanism to vent excess water vapour from the reservoir after the heating stage has completed. Further, as each of the process steps of heating, venting, dispensing of yoghurt culture and flavouring into the reservoir, stirring, and cooling the yoghurt product pre-mixture are required to be performed at precise times, the automation of these steps alleviates the inconvenience of having the user constantly monitor the process and having to manually perform each of steps at the precise times. Yet further, embodiments of the present invention may be remotely controlled and monitored via a smartphone device without requiring a user to constantly be in proximity to the device and to monitor progress of the device operation. Further, embodiments of the present invention may conveniently be configured to perform self-cleaning by simply adding hot water in to the reservoir and activating the stirrer mechanism to allow cleaning of the reservoir.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

What is claimed is:

1. A device for use in making a yoghurt product, the device including:
a base station having a reservoir associated therewith for holding a yoghurt product pre-mixture;
a stirrer for stirring the yoghurt product pre-mixture;
a heating device;
a cooling device;
a temperature sensor module; and
a controller module operatively-connected to the temperature sensor module and configured for controlling the heating device and the cooling device to heat and cool the yoghurt product pre-mixture in the reservoir respectively, by reference to output signals of the temperature sensor received by the controller module indicative of the temperature of the yoghurt product pre-mixture in the reservoir, so as to form the yoghurt product.

2. A device as claimed in claim 1 wherein the yoghurt product pre-mixture includes an effective amount of a milk constituent and an effective amount of a yoghurt culture constituent.

3. A device as claimed in claim 1 wherein the yoghurt product pre-mixture includes an effective amount of a flavour constituent.

4. A device as claimed in claim 1 wherein the heating device and the cooling device includes an integrated heating and cooling device.

5. A device as claimed in claim 1 wherein the integrated heating and cooling device includes a thermoelectric Peltier device.

6. A device as claimed in claim 1 wherein the heating device and the cooling device are comprised by separate devices.

7. A device as claimed in claim 6 wherein the heating device includes at least one of a metallic heating device, a ceramic heating device, and a polymer heating device.

8. A device as claimed in claim 1 wherein the heating device is configured for heating the yoghurt product pre-mixture to a temperature of around 85 degrees Celsius.

9. A device as claimed in claim 6 wherein the cooling device includes a thermoelectric Peltier device.

10. A device as claimed in claim 6 wherein the heating device and the cooling device include a heat transfer element via which the heating device and the cooling device effect heat transfer in to and out of the yoghurt product pre-mixture.

11. A device as claimed in claim 10 wherein the heat transfer element is mounted adjacent to a top section of the base station and includes a first region configured for extending downwardly from the top section into contact with the yoghurt product pre-mixture within the reservoir.

12. A device as claimed in claim 10 wherein the heat transfer element includes a second region configured for thermal communication with the cooling device.

13. A device as claimed in claim 12 wherein the second region of the heat transfer element includes a substantially planar surface configured for lying substantially flush against the cooling device.

14. A device as claimed in claim 10 wherein the heat transfer element includes a third region comprising a hollow recess of the heat transfer element configured for receiving the heating element therein.

15. A device as claimed in claim 2 including a dispenser for dispensing at least one of the milk constituent, the yoghurt culture constituent and the flavour constituent into the reservoir to form the yoghurt product pre-mixture.

16. A device as claimed in claim 15 wherein the dispenser includes a receptacle for releasably receiving at least one of the milk constituent, the yoghurt culture constituent and the flavour constituent for dispensing into the reservoir to form the yoghurt product pre-mixture.

17. A device as claimed in claim 16 wherein the receptacle includes an opening and a blocking member configured for movement relative to the opening between at least a first position wherein the at least one of the milk constituent, the yoghurt culture constituent and the flavour constituent is able to be dispensed into the reservoir via the opening, and, a second position whereby the blocking member prevents the at least one of the milk constituent, the yoghurt culture constituent and the flavour constituent from being dispensed into the reservoir via the opening.

18. A device as claimed in claim 17 including a magnetic drive mechanism is configured for moving the blocking member relative to the opening of the receptacle.

19. A device as claimed in claim 2 wherein at least one of the milk constituent, the yoghurt culture constituent and the flavour constituent are formed as a solid mass.

20. A device as claimed in claim 19 wherein the solid mass includes compressed powder tablet.

21. A device as claimed in claim 1 wherein the stirrer includes a stirrer tool head configured for attachment to the first region of the heat transfer element extending in to the reservoir and wherein the first region of the heat transfer element is configured for rotation so as to rotate the stirrer tool head attached thereon.

22. A device as claimed in claim 21 wherein the stirrer tool head is releasably attachable to the first region of the heat transfer element.

23. A device as claimed in claim 21 wherein the stirrer tool head is configured for slide fitting over an end of the first region of the heat transfer element.

24. A device as claimed in claim 21 including a magnetic attachment mechanism disposed on at least one of the stirrer tool head and the heat transfer element to effect magnetic attachment of the stirrer tool head to the heat transfer element.

25. A device as claimed in claim 21 wherein the reservoir is removably receivable within a recess of the base module.

26. A device as claimed in claim 1 including a venting module configured for venting water vapour from the reservoir when received within the recess of the base module.

27. A device as claimed in claim 26 wherein the venting module is configured for moving the reservoir between at least one of a closed position whereby a gap between a rim of the reservoir and the top section of the base station is at a relative minimum, and, an opened position whereby the gap between the rim of the reservoir and the top section of the base station is at a relative maximum.

28. A device as claimed in claim 27 wherein the venting module is configured for moving the reservoir upwardly and downwardly within the recess between the closed position and the opened position by sliding motion along a linear axis.

28. A device as claimed in claim 27 wherein the venting module is configured for tilting, rotating or sliding the reservoir vertically within the recess from the closed position in to the opened position in order to vent the water vapour from the reservoir.

29. A device as claimed in claim 1 including a controller module configured for controlling operation of at least one of the dispenser, the stirrer, the temperature sensor module, the heating device, and the cooling device in accordance with at least one predefined operational mode setting for producing the yoghurt product.

30. A device as claimed in claim 29 wherein the controller module is configured for controlling operation of at least one of the dispenser, the stirrer, the temperature sensor module, the heating device, and the cooling device in accordance with a plurality of different predefined operational mode settings to produce a plurality of different types of yoghurt products.

31. A device as claimed in claim 29 wherein the controller module is communicably connected with a data store for storing data representing the at least one predefined operational mode setting, whereby the controller module is able to access the data from the data store in order to control operation of the at least one of the dispenser, the stirrer, the temperature sensor module, the heating device, and the cooling device in accordance with the at least one predefined operational mode setting for producing the yoghurt product.

32. A device as claimed in claim 31 wherein the data store includes at least one of a data store of the device, a server-side data store, and a cloud-based data store.

33. A device as claimed in claim 29 wherein the controller module is communicably connected with a user-interactive interface via which the at least one predefined operational mode setting may be selected by the user, and responsive to said selection being made, the controller module is configured for controlling operation of the at least one of the dispenser, the stirrer, the temperature sensor module, the heating device, and the cooling device in accordance with the at least one predefined operational mode setting for producing the yoghurt product.

34. A device as claimed in claim 33 wherein the user-interactive interface is comprised by an electronic device configured for remote connection with the controller module via a communication link.

35. A device as claimed in claim 34 wherein the electronic device includes at least one of a smartphone, a tablet-type device and a portable computer.

36. A device as claimed in claim 34 wherein the communication link includes at least one wireless communication link.

37. A device as claimed in claim 1 including at least one of a weight sensor and a proximity sensor configured for sensing the yoghurt product presence of the milk constituent in the reservoir, wherein responsive to said sensing of the yoghurt product presence of the milk constituent in the reservoir, the controller module is configured for controlling operation of the at least one of the dispenser, the stirrer, the temperature sensor module, the heating device, and the cooling device in accordance with the at least one predefined operational mode setting for producing the yoghurt product.

38. A device as claimed in claim 29 wherein the at least one predefined operational mode setting includes at least one of a predefined stirring time of the stirrer, a predefined heating temperature of the heating device, a predefined cooling temperature of the cooling device, a predefined heating time of the heating device, and a predefined cooling time of the cooling device.

39. A device as claimed in claim 1 wherein the user-interactive interface is configured to output a notification in response to sensing of the yoghurt product having been formed in the reservoir.

40. A device as claimed in claim 1 wherein the microcontroller module is configured for controlling operation of at least one of the dispenser, the stirrer, the temperature sensor module, the heating device, and the cooling device in accordance with at least one predefined operational mode setting for cleaning the reservoir.
